(19) United States
(12) Patent Application Publication
(10) Pub. No.: US 2015/0234156 A1
(43) Pub. Date: Aug. 20, 2015

(54) APPARATUS AND METHOD FOR PANORAMIC VIDEO IMAGING WITH MOBILE COMPUTING DEVICES

(71) Applicant: 360fly, Inc., Canonsburg, PA (US)

(72) Inventors: Michael Rondinelli, Canonsburg, PA (US); Chang Glasgow, Canonsburg, PA (US)

(21) Appl. No.: 14/700,775

(22) Filed: Apr. 30, 2015

Related U.S. Application Data
(62) Division of application No. 13/448,673, filed on Apr. 17, 2012.
(60) Provisional application No. 61/476,634, filed on Apr. 18, 2011.

(51) Int. Cl. G02B 13/06; G02B 5/10; G03B 37/00

(52) U.S. Cl. CPC G02B 13/06; G03B 37/00; G02B 5/10

(57) ABSTRACT

An apparatus includes a housing, a concave panoramic reflector, a support structure configured to hold the concave panoramic reflector in a fixed position with respect to the housing, and a mounting device for positioning the housing in a fixed orientation with respect to a computing device such that light reflected by the concave panoramic reflector is directed to a light sensor in the computing device.

### CROSS REFERENCE TO RELATED APPLICATIONS

This application is a divisional application of U.S. patent application Ser. No. 13/448,673, filed Apr. 17, 2012, which claims the benefit of U.S. Provisional Application Ser. No. 61/476,634, filed Apr. 18, 2011. Both of these applications are hereby incorporated by reference.

### FIELD OF THE INVENTION

The present invention relates to an apparatus and method for panoramic video imaging.

### BACKGROUND INFORMATION

Panoramic imaging systems including optical devices, unwarping software, displays and various applications are disclosed in U.S. Pat. Nos. 6,963,355; 6,594,448; 7,058,239; 7,399,095; 7,139,440; 6,856,472; and 7,123,777 assigned to Eyesee360, Inc. All of these prior patents are incorporated herein by reference.

### SUMMARY

In one aspect, the invention provides an apparatus including a housing, a concave panoramic reflector, a support structure configured to hold the concave panoramic reflector in a fixed position with respect to the housing, and a mounting device for positioning the housing in a fixed orientation with respect to a computing device such that light reflected by the concave panoramic reflector is directed to a light sensor in the computing device.

### BRIEF DESCRIPTION OF DRAWINGS

FIGS. 1A, 1B and 1C illustrate a panoramic optical device.

FIGS. 2A, 2B and 2C illustrate a panoramic optical device.

FIGS. 3A, 3B, 3C, 3D, 3E and 3F illustrate a panoramic optical device.

FIGS. 4A, 4B and 4C illustrates a case attached to a mobile computing device.

FIGS. 5A, 5B, 6A, 6B, 7A, 7B, 8A, 8B, 9A, 9B, 9C, 10A and 10B illustrate structures for mounting a panoramic optical device to a mobile computing device such as an iPhone®.

FIGS. 11A, 11B, 11C, 11D and 11E illustrate another panoramic optical device.

FIGS. 12A, 12B and 12C illustrate a case attached to a mobile computing device.

FIGS. 13 and 14 illustrate panoramic mirror shapes.

FIGS. 15-17 are flow charts illustrating various aspects of image processing.

FIGS. 18, 19A and 19B illustrate interactive display features of a mobile computing device.

FIGS. 20, 21 and 22 illustrate orientation based display features of a mobile computing device.

FIG. 23 is a flow chart illustrating video and audio processing.

### DETAILED DESCRIPTION

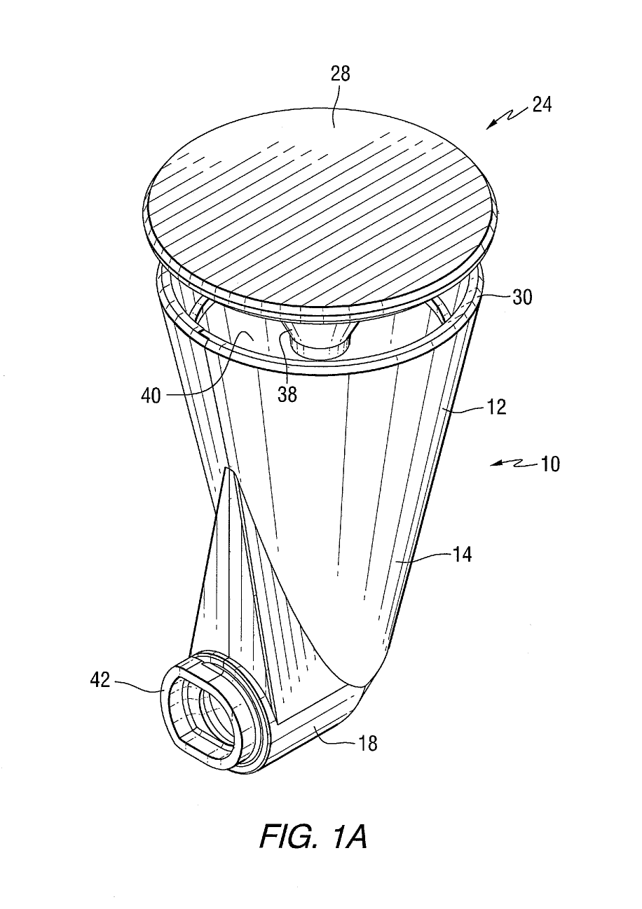

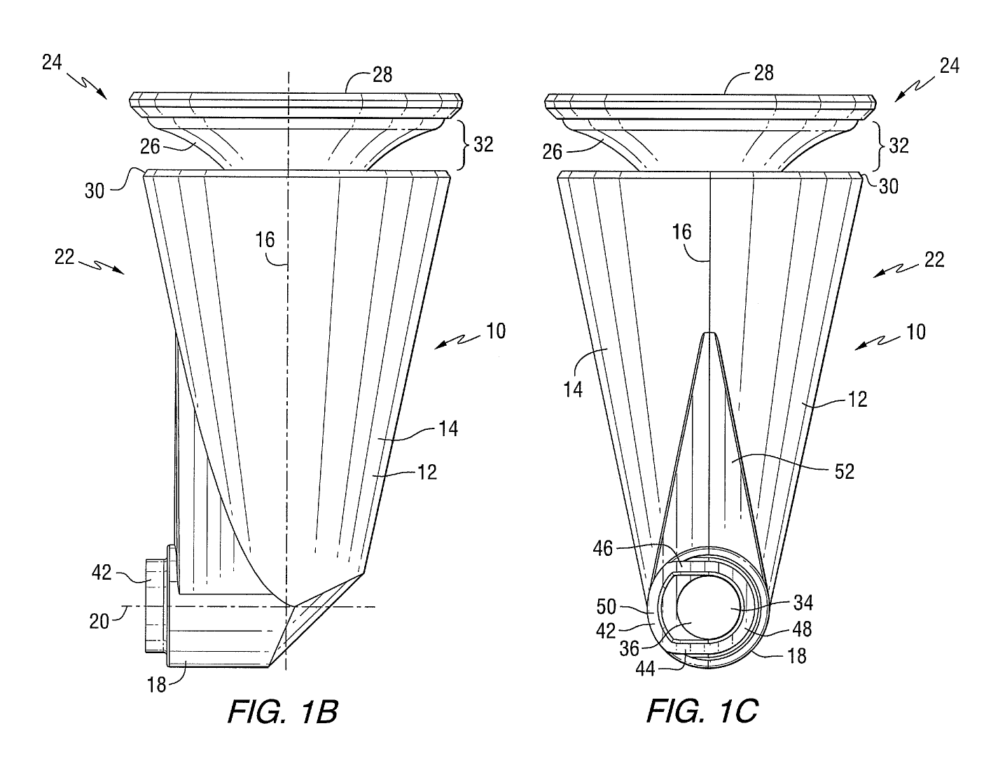

FIGS. 1A, 1B and 1C illustrate a panoramic optical device 10 (also referred to herein as an optic) for attachment to a computing device, in accordance with an embodiment of the invention. In various embodiments, the computing device can be a mobile computing device such as an iPhone®, or other phone that includes a camera. In other embodiments, the computing device can be a stationary or portable device that includes components that have signal processing capabilities needed to perform at least some of the functions described herein. The computing device may include a camera or other image sensor, or may be capable of receiving image data from a camera or other image sensor.

FIG. 1A is an isometric view, FIG. 1B is a side view, and FIG. 1C is a front view of an embodiment of the optical device 10. The device includes a housing 12. In this embodiment, the housing includes a first portion 14 having a first axis 16 and a second portion 18 having a second axis 20. For convenience, the first axis can be referred to as a vertical axis and the second axis can be referred to as a horizontal axis. However the spatial orientation of the axes will depend on the orientation of the device when in use. At least a part 22 of the first portion of the housing has a frustoconical shape. A reflector assembly 24 is attached to the first portion of the housing and centered along a first axis 16 of the housing. The reflector assembly includes concave panoramic mirror 26 extending downward from a top portion 28. The panoramic mirror extends into the housing and beyond an end 30 of the housing to create a gap 32. Light entering the gap is reflected by the concave panoramic mirror 26 into the housing. A second mirror 34 is mounted within the housing to direct the light toward an opening 36. In one embodiment, the second mirror is a planar mirror positioned at a 45° angle with respect to both the first axis 16 and the second axis 20. Light is reflected off of the second mirror in a direction toward the opening 36 at an end of the second portion of the housing. The reflector assembly further includes a post 38 positioned along axis 16 and coupled to a transparent support member 40. By mounting the reflector assembly in this manner, the use of other support structures (which could result in glare) is avoided.

The housing 12 further includes a projection 42 extending from the second portion, and shaped to couple to a case or other mounting structure that is used to couple the optical device to a computing device and to hold the optical device in a fixed orientation with respect to the computing device. In the embodiment of FIGS. 1A, 1B and 1C the projection has an oblong shape with two elongated sides 44, 46 and two arcuate ends 48 and 50. In this embodiment, the radius of curvature of end 48 is smaller than the radius of curvature of end 50. This prevents the end 50 from extending beyond a side of the optical device housing in a lateral direction. However, the projection can fit within an oblong opening in a case or other mounting structure and still maintain the relative orientation of the optical device housing and the case or other mounting structure.

The optical device housing further includes a generally triangularly shaped potion 52 extending between sides of the first and second portions. The triangular portion can function as an enlarged fingerhold for insertion and removal.

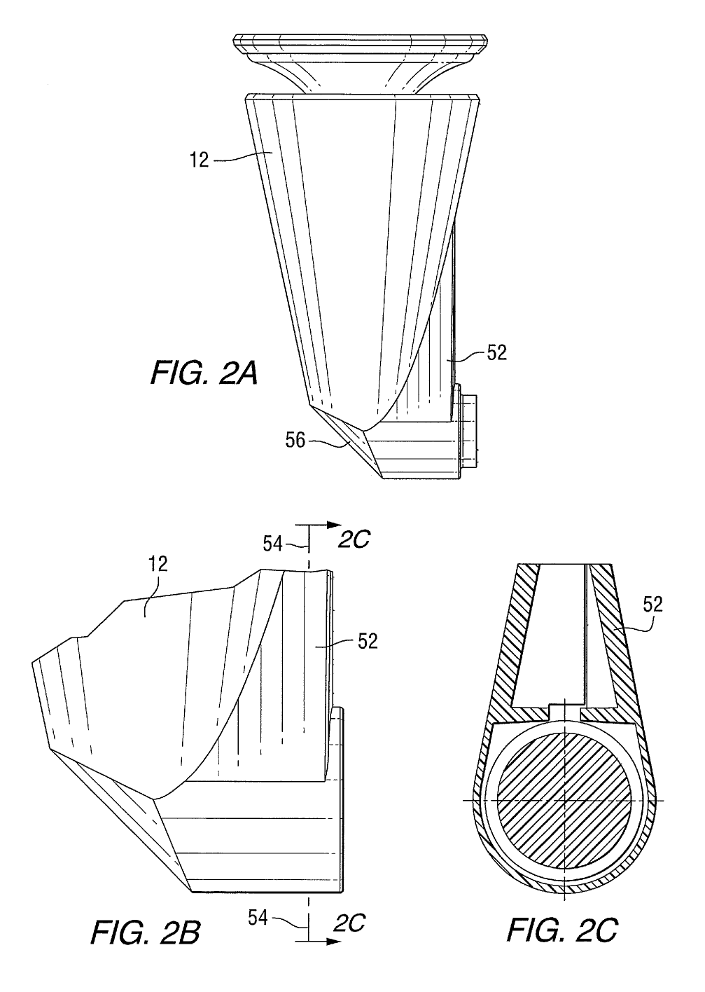

FIGS. 2A, 2B and 2C illustrate additional features of the panoramic optical device of FIGS. 1A, 1B and 1C. FIG. 2A is a side view of the optical device. FIG. 2B is an enlarged view of a lower portion of the optical device. FIG. 2C is a cross-sectional view of FIG. 2B taken along line 54-54. The housing includes a planar section 56 that lies at a 45° angle with respect to both the first axis 16 and the second axis 20 of FIG. 1B. FIGS. 2A, 2B and 2C show a hidden mechanical interface 58 between the primary housing and the mounting point. The interface is designed to provide vertical alignment between the parts, with some forgivance to make it easier to handle and harder to damage.

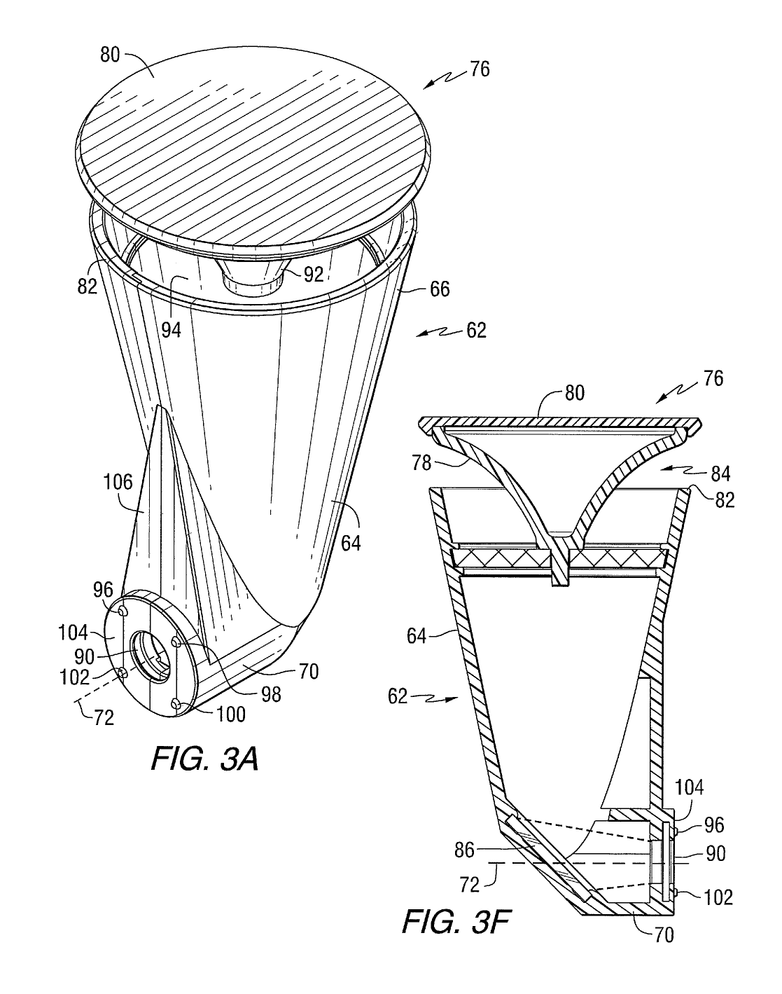

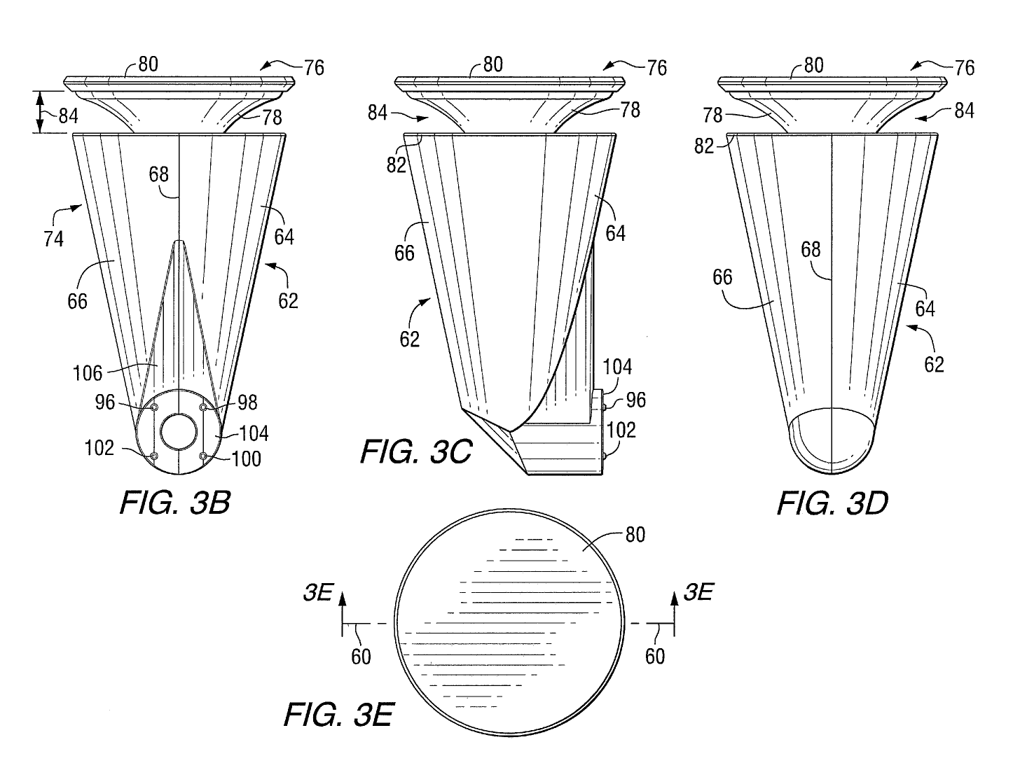

FIGS. 3A, 3B, 3C, 3D, 3E and 3F illustrate a panoramic optical device in accordance with another embodiment of the invention. This embodiment is similar to the embodiment of FIGS. 1A, 1B and 1C but includes a different structure for coupling to a computing device. FIG. 3A is an isometric view, FIG. 3B is a front view, FIG. 3C is a side view, FIG. 3D is a back view, FIG. 3E is a top view, FIG. 3F is a cross-sectional view taken along line 60-60, of an embodiment of the optical device 62. The device includes a housing 64. The housing includes a first portion 66 having a first axis 68 and a second portion 70 having a second axis 72. For convenience, the first axis can be referred to as a vertical axis and the second axis can be referred to as a horizontal axis. However the spatial orientation of the axes will depend on the orientation of the device when in use. At least a part 74 of the first portion of the housing has a frustoconical shape. A reflector assembly 76 is attached to the first portion of the housing and centered along the first axis 68 of the housing. The reflector assembly includes concave panoramic mirror 78 extending downward from a top portion 80. The panoramic mirror extends into the housing and beyond an end 82 of the housing to create a gap 84. Light entering the gap is reflected into the housing. A second mirror 86 mounted within the housing to direct the light toward an opening 90. In one embodiment, the second mirror is a planar mirror positioned at a 45° angle with respect to both the first axis 68 and the second axis 72. Light is reflected off of the second mirror in a direction toward the opening 90 at an end of the second portion of the housing. The reflector assembly further includes a post 92 positioned along axis 68 and coupled to a transparent support member 94.

The housing 62 further includes a plurality of protrusions 96, 98, 100 and 102 extending from a flat surface 104 of the second portion, and shaped to couple to a plurality of recesses in a case or other mounting structure that is used to couple the optical device to a computing device and to hold the optical device in a fixed orientation with the computing device. The housing further includes a generally triangularly shaped potion 106 extending between sides of the first and second portions. The rotational symmetry of the protrusions allows the mount to interface in up to four different orientations for operation.

The curvature of the panoramic mirror can be altered to provide different fields of view. The gap 84 may provide a further constraint based on what rays of light it occludes from reflection. Possible fields of view may range from −90 degrees below the horizon to about 70 degrees above, or anything in between.

The mirror 86 is sized to reflect light encompassed by the field of view of a camera in the computing device. In one example, the camera vertical field of view is 24°. However, the size and configuration of the components of the optical device can be changed to accommodate cameras having other fields of view.

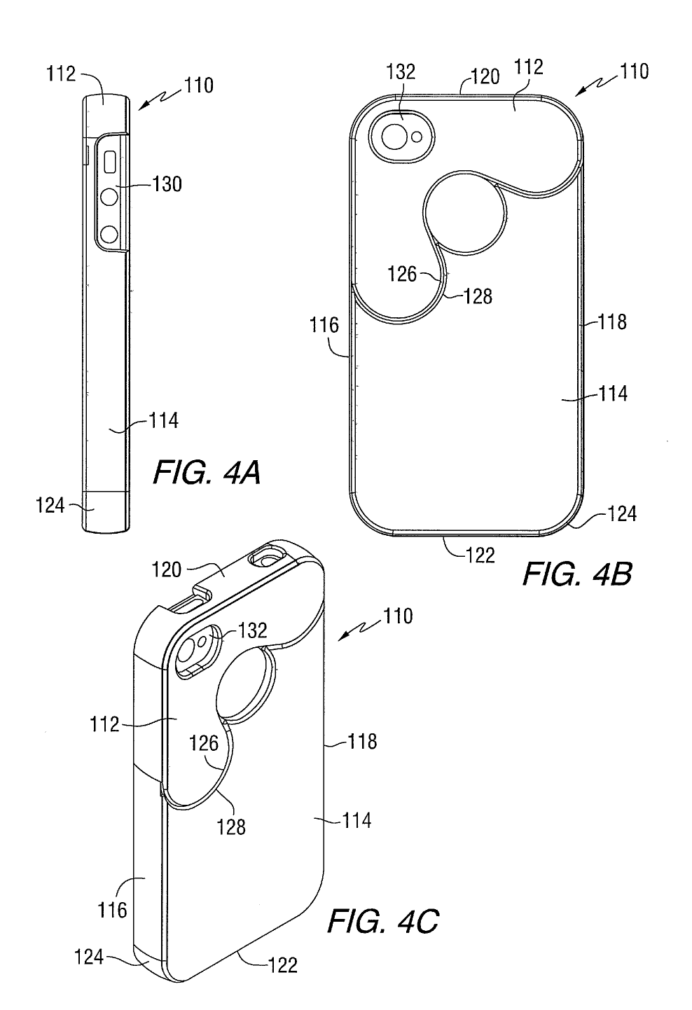

FIGS. 4A, 4B and 4C illustrate a case attached to a mobile computing device in accordance with an embodiment of the present invention. FIG. 4A is a side view, FIG. 4B is a front view, and FIG. 4C is an isometric view of an embodiment of the case 110. The case 110 includes two sections 112 and 114. The case depicted in FIGS. 4A, 4B and 4C is designed to serve as a mounting fixture for coupling the optical device to a mobile computing device such as an iPhone®. The side walls 116, 118, 120 and 122 of the case contain a small lip 124, designed to grip a beveled edge along the outside of the screen of the iPhone®. When the two sections of the case are slid onto the iPhone®, this front lip holds the back face of the case in tension against the back of the iPhone®. The two sections are joined by a pair of parallel, angled surfaces 126, 128, forming a snap fit when the two parts are slid onto the iPhone® and then pressed together. Openings 130, 132 in the case are positioned to allow access to the various buttons and the camera on the back. When the optical devices is coupled to the case, the opening 132 for the camera forms an interference fit against the protruding barrel on the front of the optic device of FIGS. 1A, 1B and 1C, keeping the two aligned and mated when the optical device is attached.

The case includes a smoothly contoured lip, symmetric on both parts and formed continuously over a curved path. It is designed to provide a positive “snap” action when attached, and an equal removal and insertion force. The smooth contour is designed to avoid wear from repeated cycles. It also imparts a tension that pulls the two sections together to form a tight fit around the phone, which aids in keeping alignment between the camera opening 132 and the iPhone® camera. The opening 132 can be slightly undersized with respect to the protruding barrel on the optic. This provides an interference fit which increases the holding force of the case. Additionally, the profile of the barrel could bulge outwards to fit into the opening. The opening 132 may taper out towards the phone, which would provide additional holding force.

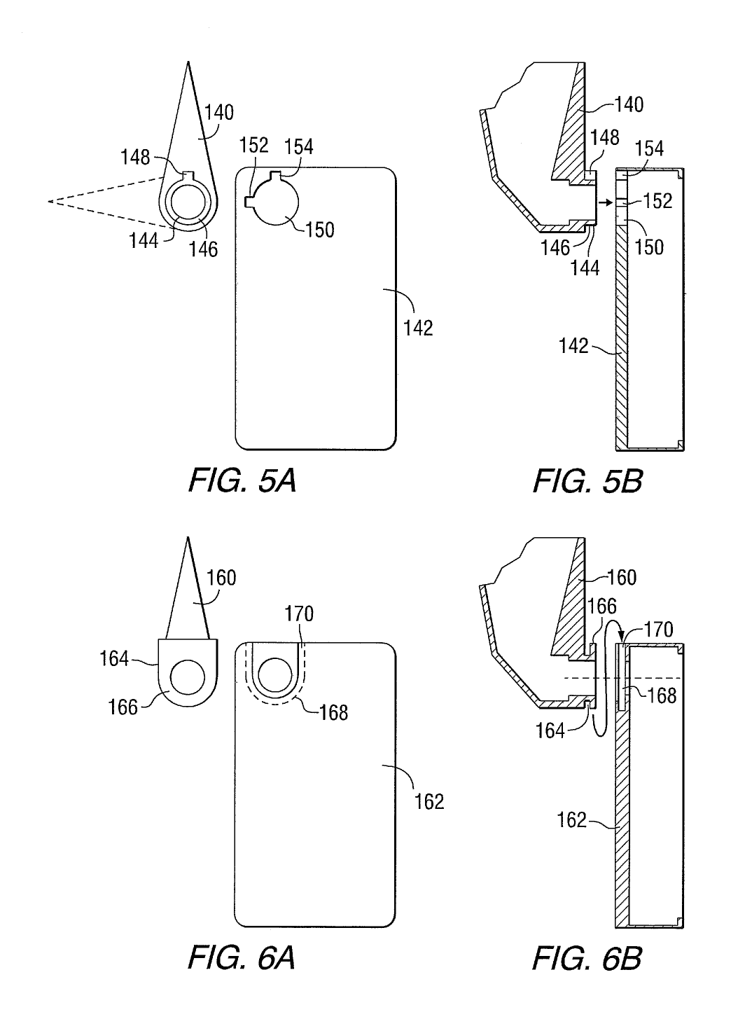

FIGS. 5A, 5B, 6A, 6B, 7A, 7B, 8A, 8B, 9A, 9B, 9C, 10A and 10B illustrate various structures for mounting a panoramic optical device to a mobile computing device such as an iPhone® in accordance with various embodiments of the invention.

FIGS. 5A and 5B are schematic front and side views, respectively, of a portion of an optical device 140 and a case 142 for a computing device in accordance with an embodiment of the invention. In this embodiment, a barrel 144 protruding from the front of the optical device 140 includes a circular portion 146 and a key 148 extending from the circular portion. The phone case 142 includes an opening 150 positioned adjacent to a camera in the phone. The opening 150 includes portions 152 and 154 positioned to accept the key on the protruding barrel of the panoramic optical device. The portions 152 and 154 are positioned 90° apart to allow the optical device to be mounted in one of two alternate orientations.

FIGS. 6A and 6B are partially schematic front and side views, respectively, of an optical device 160 and a case 162 for a computing device in accordance with an embodiment of the invention. In this embodiment, a top slot interface includes a barrel 164 protruding from the front of the optical device 160 includes U-shaped bayonet portion 166. The phone case 162 includes an opening 168 positioned adjacent to a camera in the phone. The opening 168 includes a slot 170 positioned to accept the bayonet portion of the panoramic optical device.

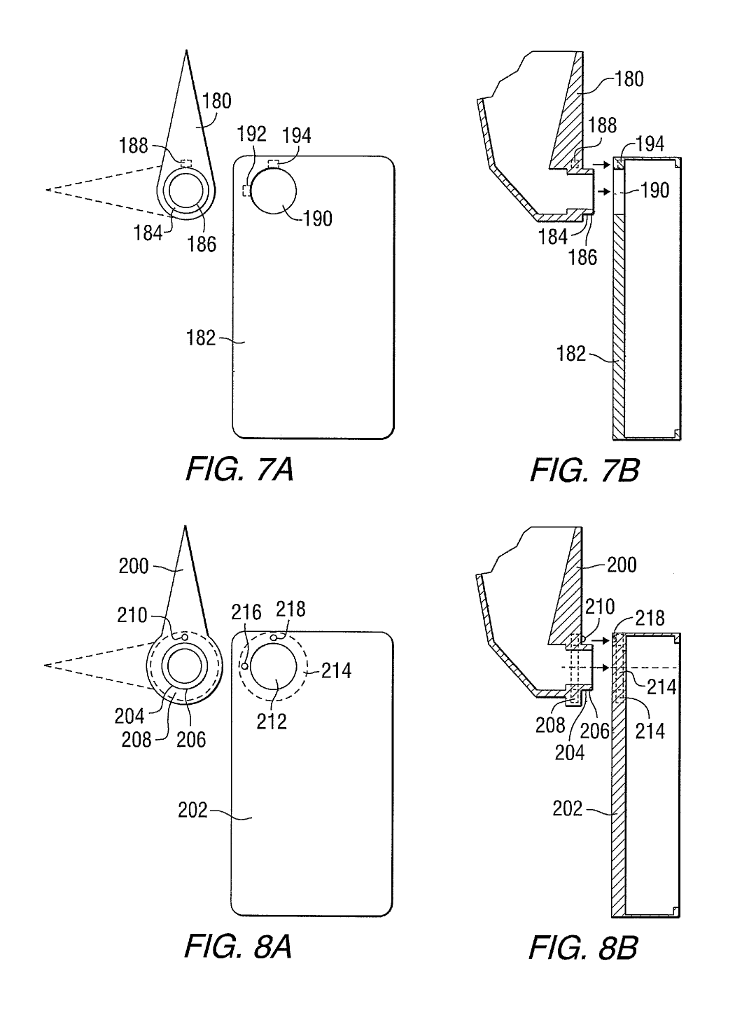

FIGS. 7A and 7B are partially schematic front and side views, respectively, of an optical device 180 and a case 182 for a computing device in accordance with an embodiment of the invention. In this embodiment, a magnet aligned interface includes a barrel 184 protruding from the front of the optical device 180 includes a circular portion 186 and a magnet 188 adjacent to the circular portion. The phone case 182 includes an opening 190 positioned adjacent to a camera in the phone. Magnets 192 and 194 in the case couple to the magnets of the panoramic optic device.

FIGS. 8A and 8B are partially schematic front and side views, respectively, of an optical device 200 and a case 202 for a computing device in accordance with an embodiment of the invention. In this embodiment, a magnet interface with bump alignment includes a barrel 204 protruding from the front of the optical device 200 includes a circular portion 206, a magnet 208 extending around the circular portion, and an alignment bump 210. The phone case 202 includes an opening 212 positioned adjacent to a camera in a phone. A magnet 214 is positioned to couple to the magnet of the panoramic optic device, and recesses 216, 218 are provided to receive the alignment bump.

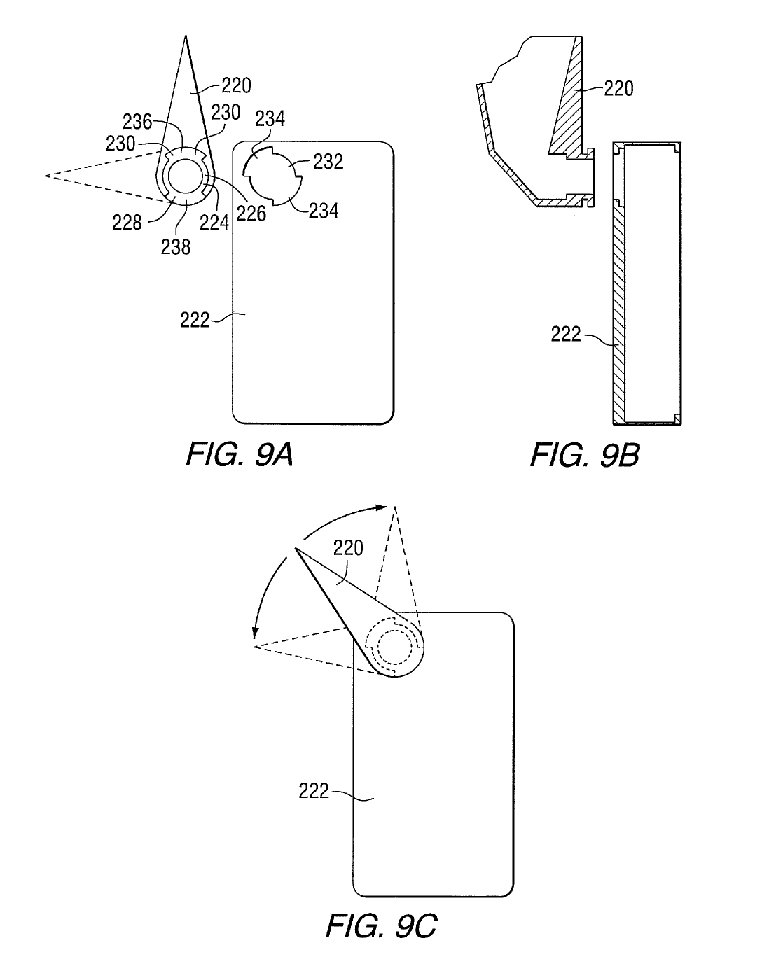

FIGS. 9A and 9B are partially schematic front and side views, respectively, of an optical device 220 and a case 222 for a computing device in accordance with an embodiment of the invention. FIG. 9C is a front view illustrating rotational movement of the optic after it is mounted on the mobile computing device. In this embodiment, a quarter turn interface includes a barrel 224 protruding from the front of the optical device 220 includes a circular portion 226 and flanges 228, 230 extending from the circular portion. The phone case 222 includes an opening 232 positioned adjacent to a camera in a phone. The opening 232 includes portions 234 positioned to accept the flanges on the protruding barrel of the panoramic optic device. The flanges include stops 236 and 238 that limit rotational movement of the optic, so that the optic can be positioned in a vertical or horizontal orientation the respect to the case, as shown in FIG. 9C.

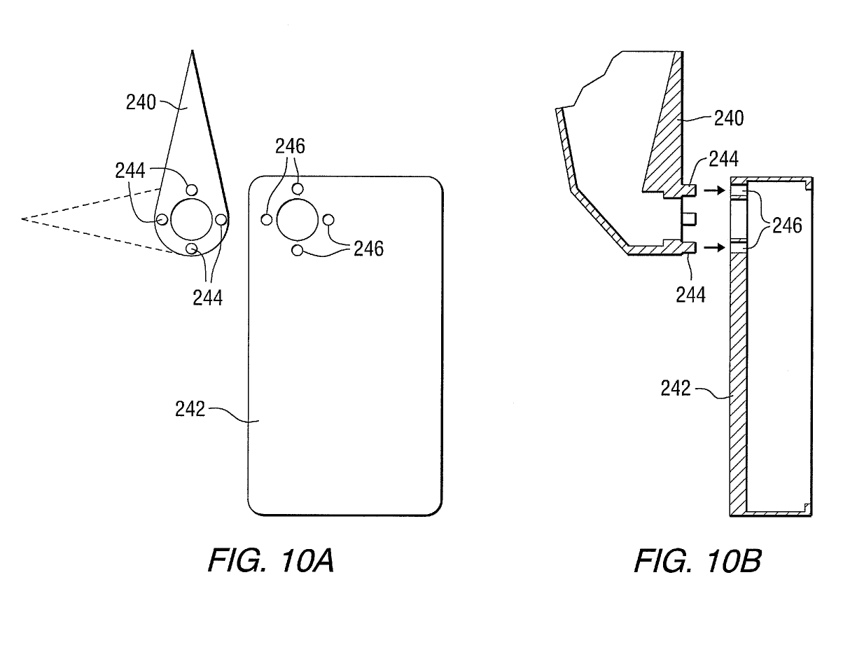

FIGS. 10A and 10B are partially schematic front and side views, respectively, of an optical device 240 and a case 242 for a computing device in accordance with an embodiment of the invention. In this embodiment, a four pin interface includes a plurality of pins 244 protrude extend from the front of the optical device 240. The phone case 242 includes a plurality of holes 246 positioned adjacent to an opening next to a camera in the phone. The pins can be slightly oversized with respect to the holes, providing an interference fit that holds the two parts together. Additionally, the profile of the pins could bulge outwards to fit into holes that taper out towards the phone, which would provide additional holding force.

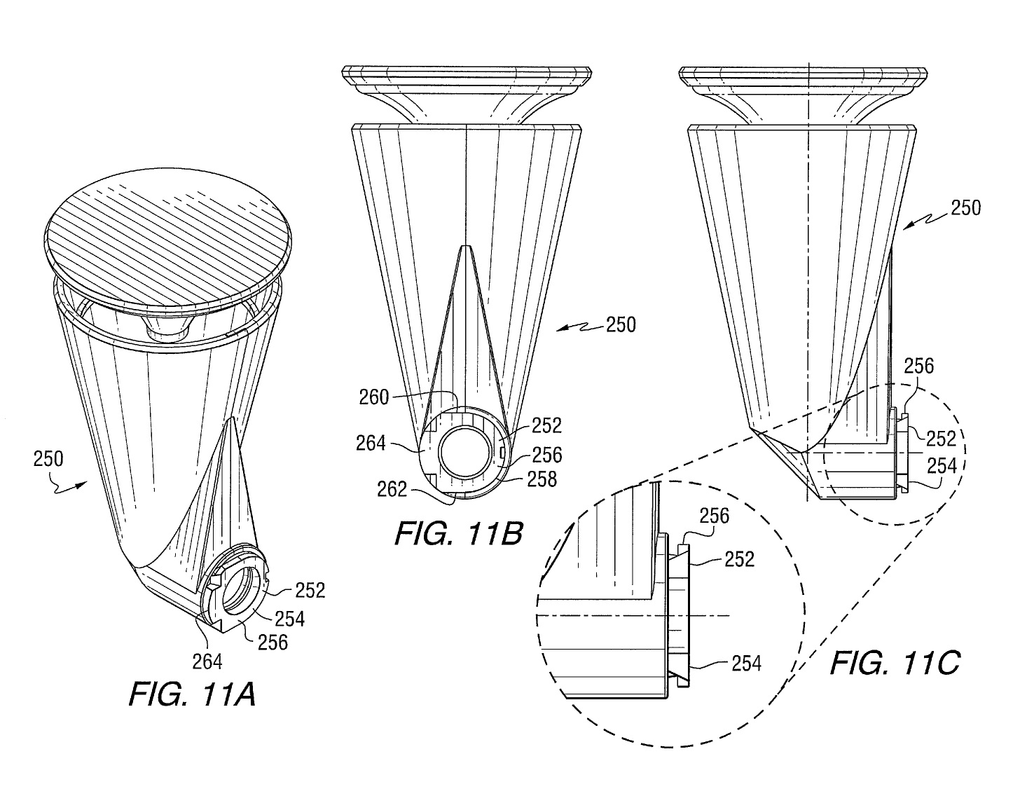

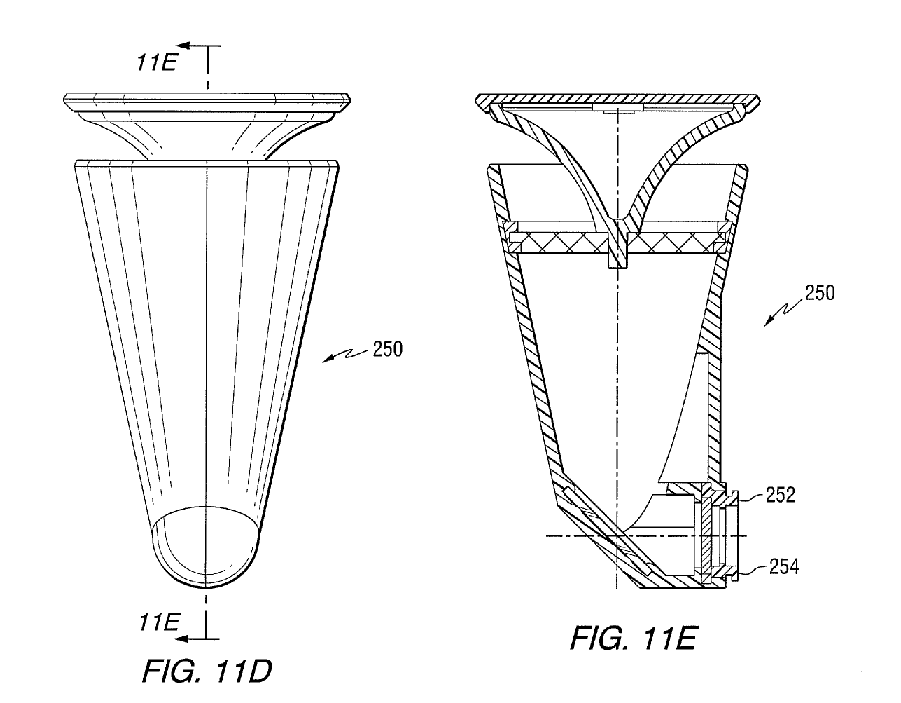

FIG. 11A is an isometric view, FIG. 11B is a front view, FIG. 11C is a side view, FIG. 11D is a back view, and FIG. 11E is a sectional view of another embodiment of the optical device 250. This optical device includes a panoramic reflector and housing that are similar to those described above, but includes a different structure 252 for coupling the optical device to the computing device. The coupling structure includes a protrusion 254 shaped to fit within an opening in a case for a computing device. The end of the protrusion has a generally oblong shaped flange 256 with a curved end 258 and two sides having straight portions 260, 262. The end of the flange opposite the curved end 258 includes a smaller curved end 264.

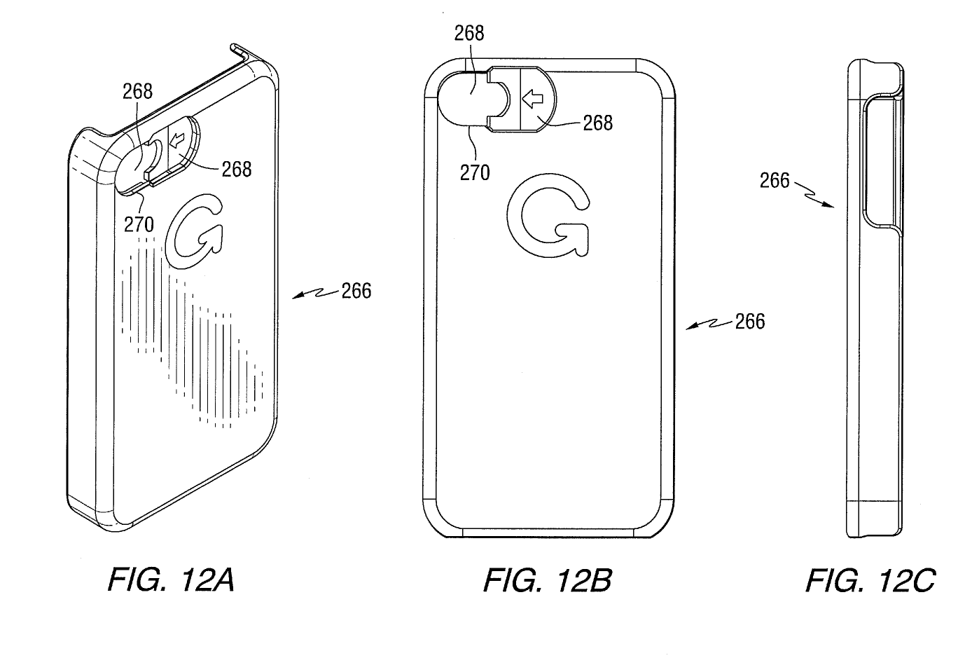

FIGS. 12A, 12B and 12C illustrates a case 266 attached to a mobile computing device. The case includes an opening 268 sized to receive the protrusion on the optical device 250. In this embodiment, the protrusion would be inserted in the right-hand side of the opening 268 and slid in the direction of the arrow. Then a lip 270 around a portion of the opening 268 would engage the flange and hold the optical device in place.

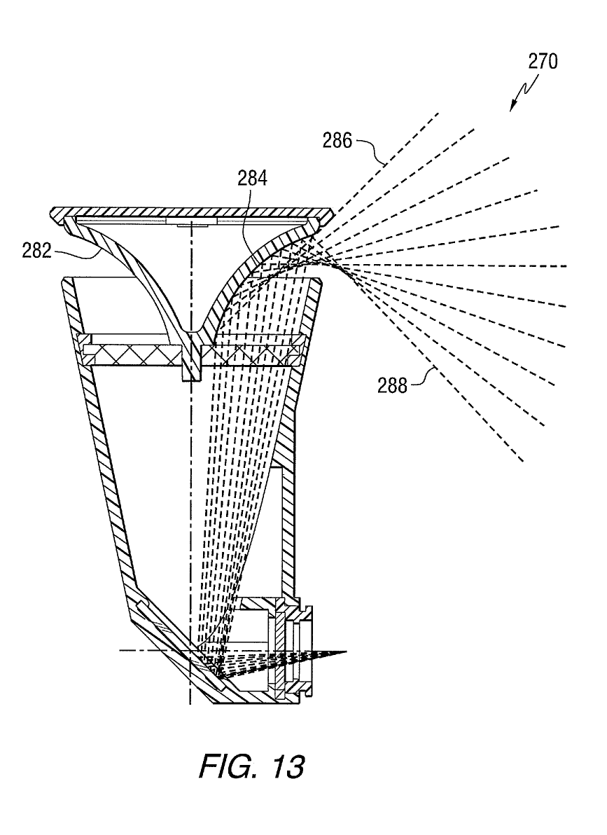

FIG. 13 illustrates light rays 280 that enter the panoramic optic, and are reflected off of the panoramic mirror 282. The panoramic mirror 282 has a concave surface 284 having a shape that can be defined by the parameters described below. The rays are reflected off of the panoramic mirror 282 and directed toward another mirror near the bottom of the optical device. The vertical field of view of the optical device is the angle between the top and bottom rays 286, 288 that enter the optical device through the opening (e.g., 84 in FIG. 3F) between the edge of the housing and the top of the mirror support structure. Rays along the outer reflected line 288 converge to a point. This property is beneficial as it reduces stray light reflected from the housing and results in a housing that has minimal volume.

The optic collects light from 360 degrees of the horizontal environment, and a subset of the vertical environment (for example, ±45° from the horizon) surrounding the optic is reflected by a curved mirror in the optic. This reflection can then be recorded by a camera, or by a recording device capable of receiving image data from a camera, to capture a panoramic still or motion image.

One or more flat, secondary mirrors can be included within the optic to accommodate a more convenient form factor or direction of capture. Secondary mirror(s) could also be curved for purposes of magnification or focus.

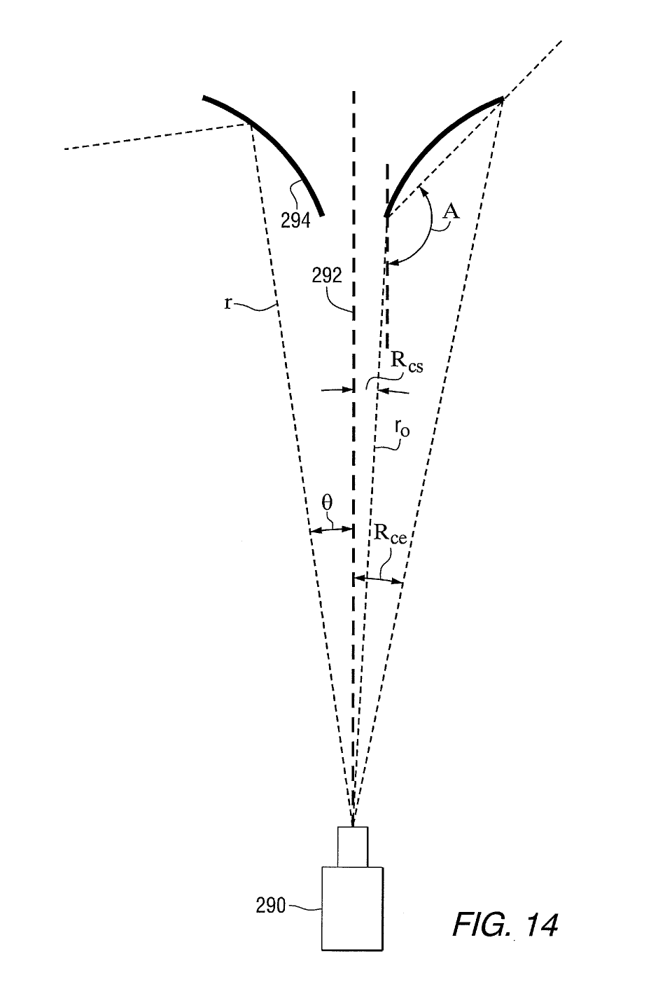

FIG. 14 illustrates panoramic mirror shapes that can be constructed in accordance with embodiments of the invention. A camera 290 positioned along a camera axis 292 receives light reflected from a concave panoramic mirror 294. The mirror shape in several embodiments can be defined by the following equations. FIG. 14 includes various parameters that appear in the equations below.

Parameters:

$$A = \frac{7 π}{9} , {R}_{cs} = \frac{π}{60} , {R}_{ce} = \frac{π}{15} , {r}_{o} = 77 , α = - 10$$

Equations:

$$\begin{matrix}k = \frac{- 1 - α}{2} \\ r ( {R}_{cs} ) = {r}_{o} & \\ ∀ θ ∈ [ {R}_{cs} , {R}_{ce} ] \text{:} \\ \frac{d r}{d ( θ + \frac{A}{α} )} = r cot ( k tan ( θ + \frac{A}{α} ) + \frac{π}{2} - k tan ( {R}_{cs} ) - \frac{{R}_{cs}}{2} ) & ( Embodiment \#1 ) \\ \frac{d r}{d ( θ + \frac{A}{α} )} = r cot ( k tan ( θ + \frac{A}{α} ) + \frac{π}{2} ) & ( Embodiment \#2 ) \\ \frac{d r}{d θ} = r cot ( k tan ( θ ) + \frac{π - A}{2} - k tan ( {R}_{cs} ) - \frac{{R}_{cs}}{2} ) & ( Embodiment \#3 )\end{matrix}$$

In the equations, A is the angle between the direction of a ray rₒ and a line parallel to the camera axis 294 in radians; Rₑₓ is the angle between the camera axis and a point on the mirror that reflects ray rₒ in radians; R_{ce} the angle between the camera axis and an edge of the mirror in radians; rₒ is the inner radius in millimeters; α is the gain factor; θ is the angle between the camera axis and the reflected ray r in radians; and k is defined in terms of α in the first equation.

In Embodiment #1, the mirror equation has been extended to take into account a camera start angle (R_{cs} expressed in radians). In the case of the Embodiment #2 mirror design, the camera start angle would be zero. Evaluating the additional terms in the Embodiment #1 with R_{cs} set to zero, the equation reduces:

$${R}_{cs} = 0$$

$$\frac{d r}{d ( θ + \frac{A}{α} )} = r cot ( k tan ( θ + \frac{A}{α} ) + \frac{π}{2} - k tan ( {R}_{cs} ) - \frac{{R}_{cs}}{2} )$$

$$\frac{d r}{d ( θ + \frac{A}{α} )} = r cot ( k tan ( θ + \frac{A}{α} ) + \frac{π}{2} - k tan ( 0 ) - \frac{0}{2} )$$

$$\frac{d r}{d ( θ + \frac{A}{α} )} = r cot ( k tan ( θ + \frac{A}{α} ) + \frac{π}{2} - k ( 0 ) - \frac{0}{2} )$$

$$\frac{d r}{d ( θ + \frac{A}{α} )} = r cot ( k tan ( θ + \frac{A}{α} ) + \frac{π}{2} )$$

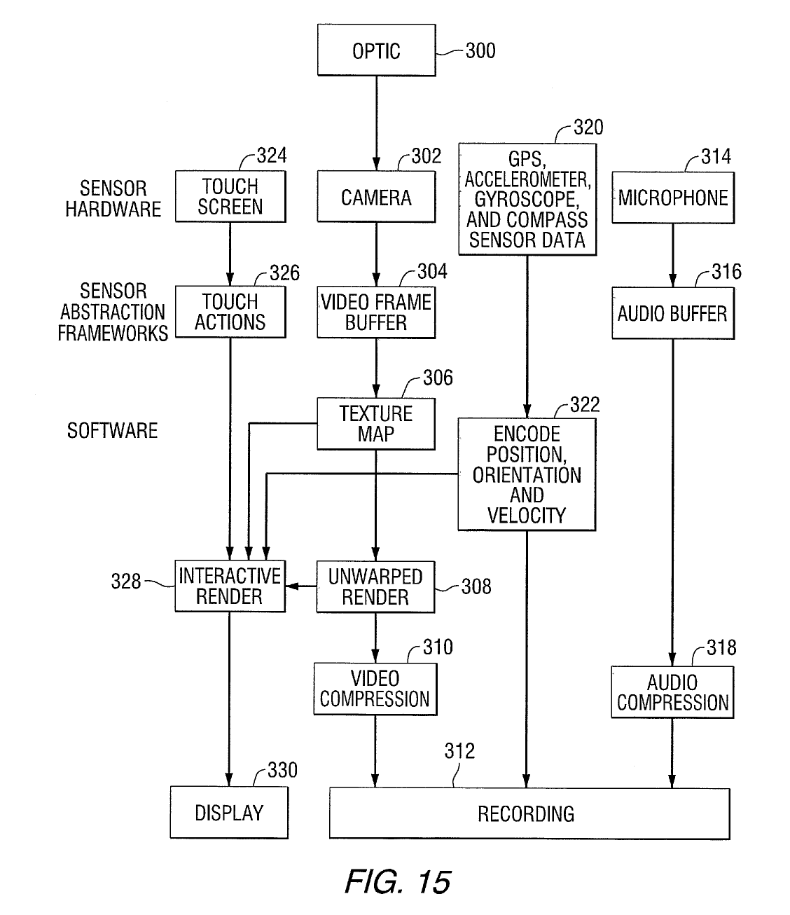

FIG. 15 is a block diagram that illustrates signal processing and image manipulation features. In the embodiment of FIG. 15, an optical device 300, such as any of those described above can be used to direct light to a camera 302. The camera outputs image pixel data to a frame buffer 304. Then the images are texture mapped 306. The texture mapped images are unwarped 308 and compressed 310 before being recorded 312.

A microphone 314 is provided to detect sound. The microphone output is stored in an audio buffer 316 and compressed 318 before being recorded. The computing device may include sensors that include a global positioning system (GPS) sensor, an accelerometer, a gyroscope, and a compass that produce data 320 simultaneously with the optical and audio data. This data is encoded 322 and recorded.

A touch screen 324 is provided to sense touch actions 326 provided by a user. User touch actions and sensor data are used to select a particular viewing direction, which is then rendered. The computing device can interactively render the texture mapped video data in combination with the user touch actions and/or the sensor data to produce video for a display 330. The signal processing illustrated in FIG. 15 can be performed by a processor or processing circuitry in a mobile computing device, such as a smart phone. The processing circuitry can include a processor programmed using software that implements the functions described herein.

Many mobile computing devices, such as the iPhone®, contain built-in touch screen or touch screen input sensors that can be used to receive user commands. In usage scenarios where a software platform does not contain a built-in touch or touch screen sensor, externally connected input devices can be used. User input such as touching, dragging, and pinching can be detected as touch actions by touch and touch screen sensors though the usage of off the shelf software frameworks.

Many mobile computing devices, such as the iPhone®, also contain built-in cameras that can receive light reflected by the panoramic mirror. In usage scenarios where a mobile computing device does not contain a built-in camera, an externally connected off the shelf camera can be used. The camera can capture still or motion images of the apparatus's environment as reflected by the mirror(s) in one of the optical devices described above. These images can be delivered to a video frame buffer for use by the software application.

Many mobile computing devices, such as the iPhone®, also contain built-in GPS, accelerometer, gyroscope, and compass sensors. These sensors can be used to provide the orientation, position and motion information used to perform some of the image processing and display functions described herein. In usage scenarios where a computing device does not contain one or more of these, externally connected off the shelf sensors can be used. These sensors provide geospatial and orientation data relating to the apparatus and its environment, which are then used by the software.

Many mobile computing devices, such as the iPhone®, also contain built-in microphones. In usage scenarios where a mobile computing device does not contain a built-in microphone, an externally connected off the shelf microphone can be used. The microphone can capture audio data from the apparatus's environment which is then delivered to an audio buffer for use by the software application.

In the event that multiple channels of audio data are recorded from a plurality of microphones in a known orientation, the audio field may be rotated during playback to synchronize spatially with the interactive renderer display.

User input, in the form of touch actions, can be provided to the software application by hardware abstraction frameworks on the software platform. These touch actions enable the software application to provide the user with an interactive presentation of prerecorded media, shared media downloaded or streamed from the internet, or media which is currently being recorded or previewed.

The video frame buffer is a hardware abstraction that can be provided by an off the shelf software framework, storing one or more frames of the most recently captured still or motion image. These frames can be retrieved by the software for various uses.

The audio buffer is a hardware abstraction that can be provided by one of the known off the shelf software frameworks, storing some length of audio representing the most recently captured audio data from the microphone. This data can be retrieved by the software for audio compression and storage (recording).

The texture map is a single frame retrieved by the software from the video buffer. This frame may be refreshed periodically from the video frame buffer in order to display a sequence of video.

The system can retrieve position information from GPS data. Absolute yaw orientation can be retrieved from compass data, acceleration due to gravity may be determined through a 3-axis accelerometer when the computing device is at rest, and changes in pitch, roll and yaw can be determined from gyroscope data. Velocity can be determined from GPS coordinates and timestamps from the software platform's clock; finer precision values can be achieved by incorporating the results of integrating acceleration data over time.

The interactive renderer 328 combines user input (touch actions), still or motion image data from the camera (via a texture map), and movement data (encoded from geospatial/orientation data) to provide a user controlled view of prerecorded media, shared media downloaded or streamed over a network, or media currently being recorded or previewed. User input can be used in real time to determine the view orientation and zoom. As used in this description, real time means that the display shows images at essentially the same time the images are being sensed by the device (or at a delay that is not obvious to a user) and/or the display shows images changes in response to user input at essentially the same time as the user input is received. By coupling the panoramic optic to a mobile computing device having a built in camera, the internal signal processing bandwidth can be sufficient to achieve the real time display.

The texture map can be applied to a spherical, cylindrical, cubic, or other geometric mesh of vertices, providing a virtual scene for the view, correlating known angle coordinates from the texture with the desired angle coordinates of each vertex. In addition, the view can be adjusted using orientation data to account for changes in the pitch, yaw, and roll of the apparatus.

An unwarped version of each frame can be produced by mapping still or motion image textures onto a flat mesh correlating desired angle coordinates of each vertex with known angle coordinates from the texture.

Many software platforms provide a facility for encoding sequences of video frames using a compression algorithm. One common algorithm is AVC or H.264 compression. This compressor may be implemented as a hardware feature of the mobile computing device, or through software which runs on the general CPU, or a combination thereof. Frames of unwarped video can be passed to such a compression algorithm to produce a compressed data stream. This data stream can be suitable for recording on the devices internal persistent memory, or transmitted though a wired or wireless network to a server or another mobile computing device.

Many software platforms provide a facility for encoding sequences of audio data using a compression algorithm. One common algorithm is AAC. The compressor may be implemented as a hardware feature of the mobile computing device, or through software which runs on the general CPU, or a combination thereof. Frames of audio data can be passed to such a compression algorithm to produce a compressed data stream. The data stream can be suitable for recording on the computing device's internal persistent memory, or transmitted though a wired or wireless network to a server or another mobile computing device. The stream may be interlaced with a compressed video stream to produce a synchronized movie file.

Display views from the interactive render can be produced using either an integrated display device such as the screen on an iPhone®, or an externally connected display device. Further, if multiple display devices are connected, each display device may feature its own distinct view of the scene.

Video, audio, and geospatial/orientation/motion data can be stored to either the mobile computing device's local storage medium, an externally connected storage medium, or another computing device over a network.

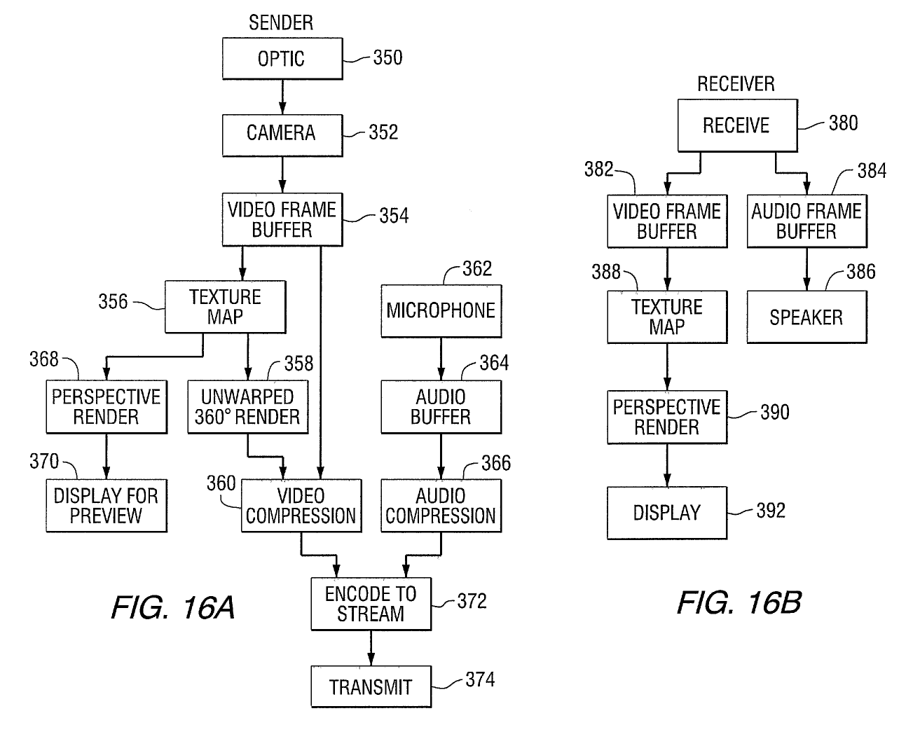

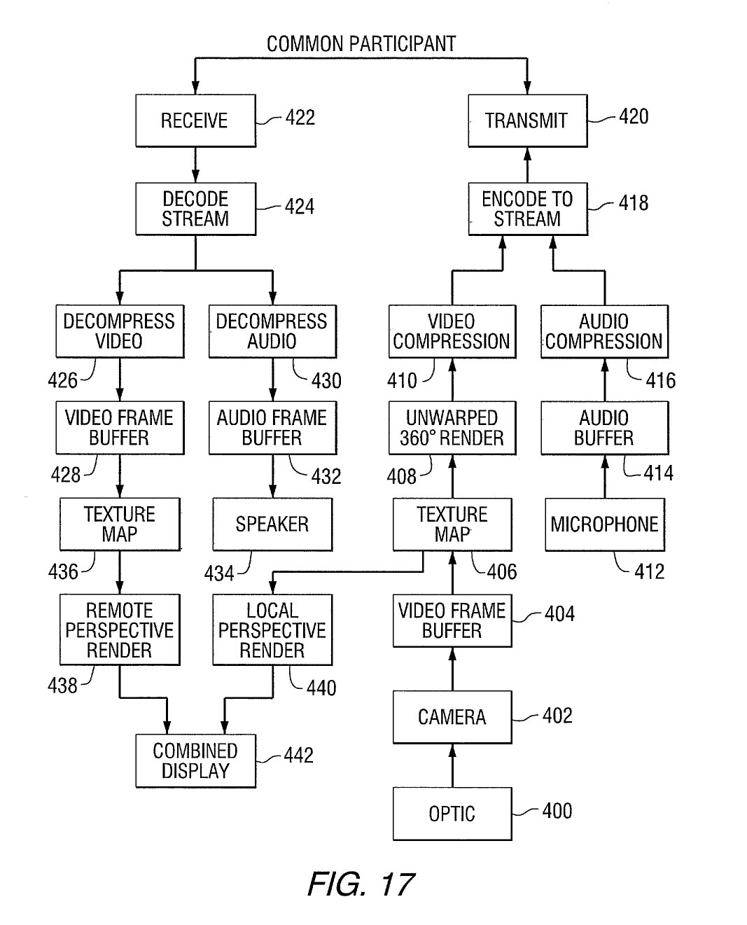

FIGS. 16A, 16B and 17 are flow charts illustrating aspects of certain signal processing techniques. FIG. 16A is a block diagram that illustrates the acquisition and transmission of video and audio information. In the embodiment illustrated in FIG. 16A, the optic 350, camera 352, video frame buffer 354, texture map 356, unwarp render 358, video compression 360, microphone 362, audio buffer 364, and audio compression 366 can be implemented in the manner described above for the corresponding components in FIG. 15. In the system of FIG. 16A, an interactive render 368 is performed on the texture map data and the rendered image is displayed for preview 370. The compressed video and audio data are encoded 372 and transmitted 374.

FIG. 16B is a block diagram that illustrates the receipt of video and audio information. In the embodiment illustrated in FIG. 16B, block 380 shows that the encoded stream is received. The video data is sent to a video frame buffer 382 and the audio data is sent to an audio frame buffer 384. The audio is then sent to a speaker 386. The video data is texture mapped 388 and the perspective is rendered 390. Then the video data is displayed on a display 392. FIGS. 16A and 16B describe a live streaming scenario. One user (the Sender) is capturing panoramic video and streaming it live to one or more receivers. Each receiver may control their interactive render independently, viewing the live feed in any direction.

FIG. 17 is a block diagram that illustrates the acquisition, transmission and reception of video and audio information by a common participant. In the embodiment illustrated in FIG. 17, the optic 400, camera 402, video frame buffer 404, texture map 406, unwarp render 408, video compression 410, microphone 412, audio buffer 414, audio compression 416, stream encoding 418, and transmission 420 can be implemented in the manner described above for FIGS. 16A and 16B. Block 422 shows that the encoded stream is received. The encoded stream is decoded 424. The video data is decompressed 426 and sent to a video frame buffer 428 and the audio data is decompressed 430 sent to an audio frame buffer 432. The audio is then sent to a speaker 434. The video data is texture mapped 436 and the perspective is remotely rendered 438. The texture mapped information is locally rendered 440. Then the rendered video data is combined and displayed 442. FIG. 17 represents an extension of the idea in FIGS. 16A and 16B for two or more live streams. A common participant may receive panoramic video from one or more other participants and may as well also transmit their own panoramic video. This would be for a “panoramic video chat” or a group chat situation.

Software for the apparatus provides an interactive display, allowing the user to change the viewing region of a panoramic video in real time. Interactions include touch based pan, tilt, and zoom, orientation based pan and tilt, and orientation based roll correction. These interactions can be made available as touch input only, orientation input only, or a hybrid of the two where inputs are treated additively. These interactions may be applied to live preview, capture preview, and pre-recorded or streaming media. As used in this description, “live preview” refers to a rendering originating from the camera on the device, and “capture preview” refers to a rendering of the recording as it happens (i.e. after any processing). Pre-recorded media may come from a video recording resident on the device, or being actively downloaded from the network to the device. Streaming media refers to a panoramic video feed being delivered over the network in real time, with only transient storage on the device.

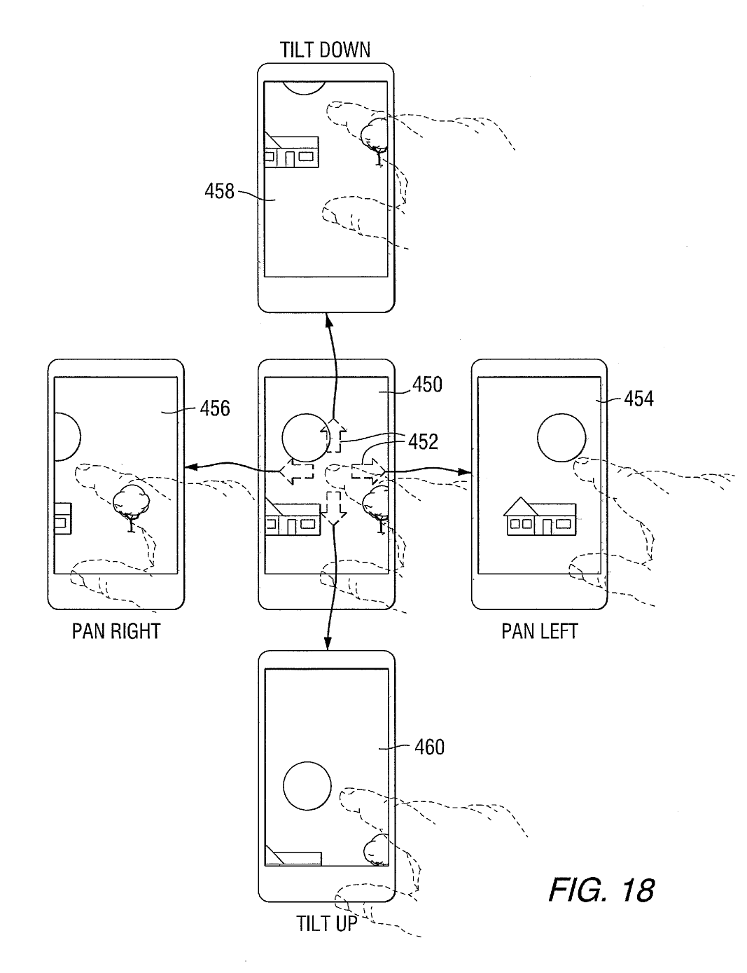

FIG. 18 illustrates pan and tilt functions in response to user commands. The mobile computing device includes a touch screen display 450. A user can touch the screen and move in the directions shown by arrows 452 to change the displayed image to achieve pan and/or tile function. In screen 454, the image is changed as if the camera field of view is panned to the left. In screen 456, the image is changed as if the camera field of view is panned to the right. In screen 458, the image is changed as if the camera is tilted down. In screen 460, the image is changed as if the camera is tilted up. As shown in FIG. 18, touch based pan and tilt allows the user to change the viewing region by following single contact drag. The initial point of contact from the user's touch is mapped to a pan/tilt coordinate, and pan/tilt adjustments are computed during dragging to keep that pan/tilt coordinate under the user's finger.

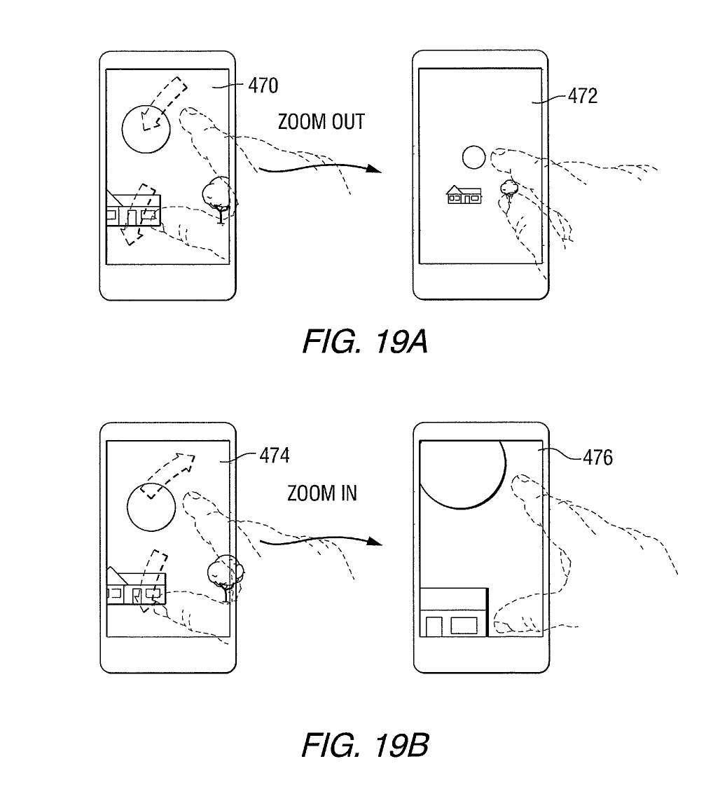

As shown in FIGS. 19A and 19B, touch based zoom allows the user to dynamically zoom out or in. Two points of contact from a user touch are mapped to pan/tilt coordinates, from which an angle measure is computed to represent the angle between the two contacting fingers. The viewing field of view (simulating zoom) is adjusted as the user pinches in or out to match the dynamically changing finger positions to the initial angle measure. As shown in FIG. 19A, pinching in the two contacting fingers produces a zoom out effect. That is, object in screen 470 appear smaller in screen 472. As shown in FIG. 19B, pinching out produces a zoom in effect. That is, object in screen 474 appear larger in screen 476.

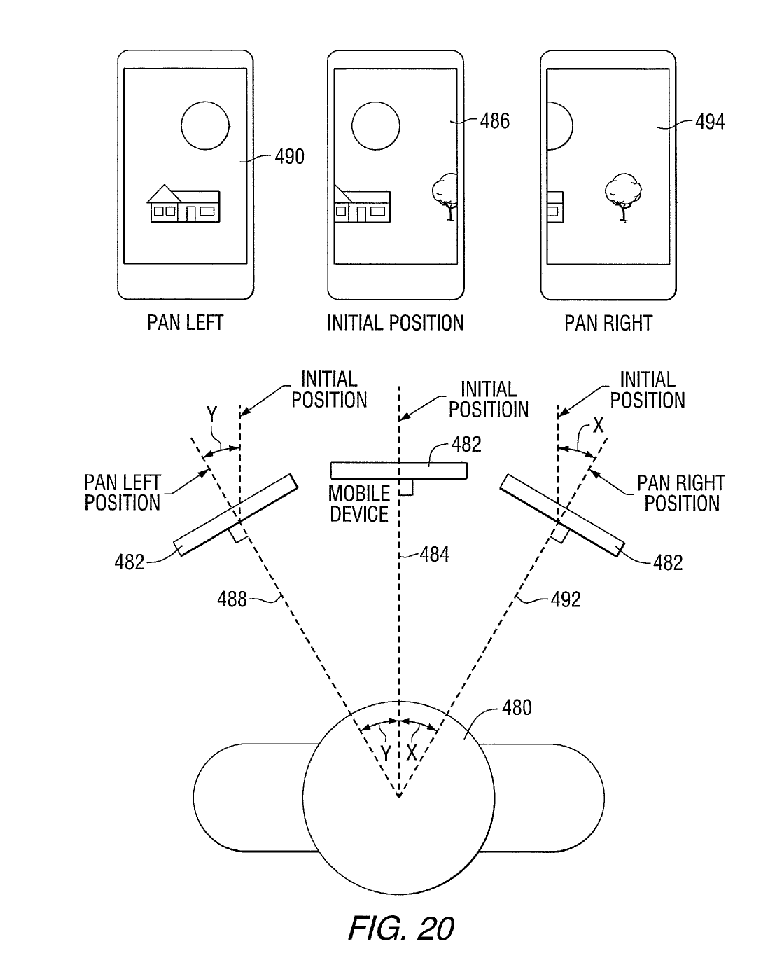

FIG. 20 illustrates an orientation based pan that can be derived from compass data provided by a compass sensor in the computing device, allowing the user to change the displaying pan range by turning the mobile device. This can be accomplished by matching live compass data to recorded compass data in cases where recorded compass data is available. In cases where recorded compass data is not available, an arbitrary North value can be mapped onto the recorded media. The recorded media can be, for example, any panoramic video recording produced as described in FIG. 13, etc. When a user 480 holds the mobile computing device 482 in an initial position along line 484, the image 486 is produced on the device display. When a user 480 moves the mobile computing device 482 in a pan left position along line 488, which is offset from the initial position by an angle y, the image 490 is produced on the device display. When a user 480 moves the mobile computing device 482 in a pan right position along line 492, which is offset from the initial position by an angle x, the image 494 is produced on the device display. In effect, the display is showing a different portion of the panoramic image capture by the combination of the camera and the panoramic optical device. The portion of the image to be shown is determined by the change in compass orientation data with respect to the initial position compass data.

Sometimes it is desirable to use an arbitrary North value even when recorded compass data is available. It is also sometimes desirable not to have the pan angle change 1:1 with the device. In some embodiments, the rendered pan angle may change at user-selectable ratio relative to the device. For example, if a user chooses 4x motion controls, then rotating the device thru 90° will allow the user to see a full rotation of the video, which is convenient when the user does not have the freedom of movement to spin around completely.

In cases where touch based input is combined with an orientation input, the touch input can be added to the orientation input as an additional offset. By doing so, conflict between the two input methods is avoided effectively.

On mobile devices where gyroscope data is available and offers better performance, gyroscope data which measures changes in rotation along multiple axes over time, can be integrated over the time interval between the previous rendered frame and the current frame. This total change in orientation can be added to the orientation used to render the previous frame to determine the new orientation used to render the current frame. In cases where both gyroscope and compass data are available, gyroscope data can be synchronized to compass positions periodically or as a one-time initial offset.

As shown in FIG. 19, orientation based tilt can be derived from accelerometer data, allowing the user to change the displaying tilt range by tilting the mobile device. This can be accomplished by computing the live gravity vector relative to the mobile device. The angle of the gravity vector in relation to the device along the device's display plane will match the tilt angle of the device. This tilt data can be mapped against tilt data in the recorded media. In cases where recorded tilt data is not available, an arbitrary horizon value can be mapped onto the recorded media. The tilt of the device may be used to either directly specify the tilt angle for rendering (i.e. holding the phone vertically will center the view on the horizon), or it may be used with an arbitrary offset for the convenience of the operator. This offset may be determined based on the initial orientation of the device when playback begins (e.g. the angular position of the phone when playback is started can be centered on the horizon). When a user 500 holds the mobile computing device 502 in an initial position along line 504, the image 506 is produce on the device display. When a user 500 moves the mobile computing device 502 in a tilt up position along line 508, which is offset from the gravity vector by an angle x, the image 510 is produce on the device display. When a user 500 moves the mobile computing device 502 in a tilt down position along line 512, which is offset from the gravity by an angle y, the image 514 is produce on the device display. In effect, the display is showing a different portion of the panoramic image captured by the combination of the camera and the panoramic optical device. The portion of the image to be shown is determined by the change in vertical orientation data with respect to the initial position compass data.

In cases where touch based input is combined with orientation input, touch input can be added to orientation input as an additional offset.

On mobile devices where gyroscope data is available and offers better performance, gyroscope data which measures changes in rotation along multiple axes over time, can be integrated over the time interval between the previous rendered frame and the current frame. This total change in orientation can be added to the orientation used to render the previous frame to determine the new orientation used to render the current frame. In cases where both gyroscope and accelerometer data are available, gyroscope data can be synchronized to the gravity vector periodically or as a one-time initial offset.

As shown in FIG. 20, automatic roll correction can be computed as the angle between the device's vertical display axis and the gravity vector from the device's accelerometer. When a user holds the mobile computing device in an initial position along line 520, the image 522 is produce on the device display. When a user moves the mobile computing device to an x-roll position along line 524, which is offset from the gravity vector by an angle x, the image 526 is produced on the device display. When a user moves the mobile computing device in a y-roll position along line 528, which is offset from the gravity by an angle y, the image 530 is produced on the device display. In effect, the display is showing a tilted portion of the panoramic image captured by the combination of the camera and the panoramic optical device. The portion of the image to be shown is determined by the change in vertical orientation data with respect to the initial gravity vector.

On mobile devices where gyroscope data is available and offers better performance, gyroscope data which measures changes in rotation along multiple axes over time, can be integrated over the time interval between the previous rendered frame and the current frame. This total change in orientation can be added to the orientation used to render the previous frame to determine the new orientation used to render the current frame. In cases where both gyroscope and accelerometer data are available, gyroscope data can be synchronized to the gravity vector periodically or as a one-time initial offset.

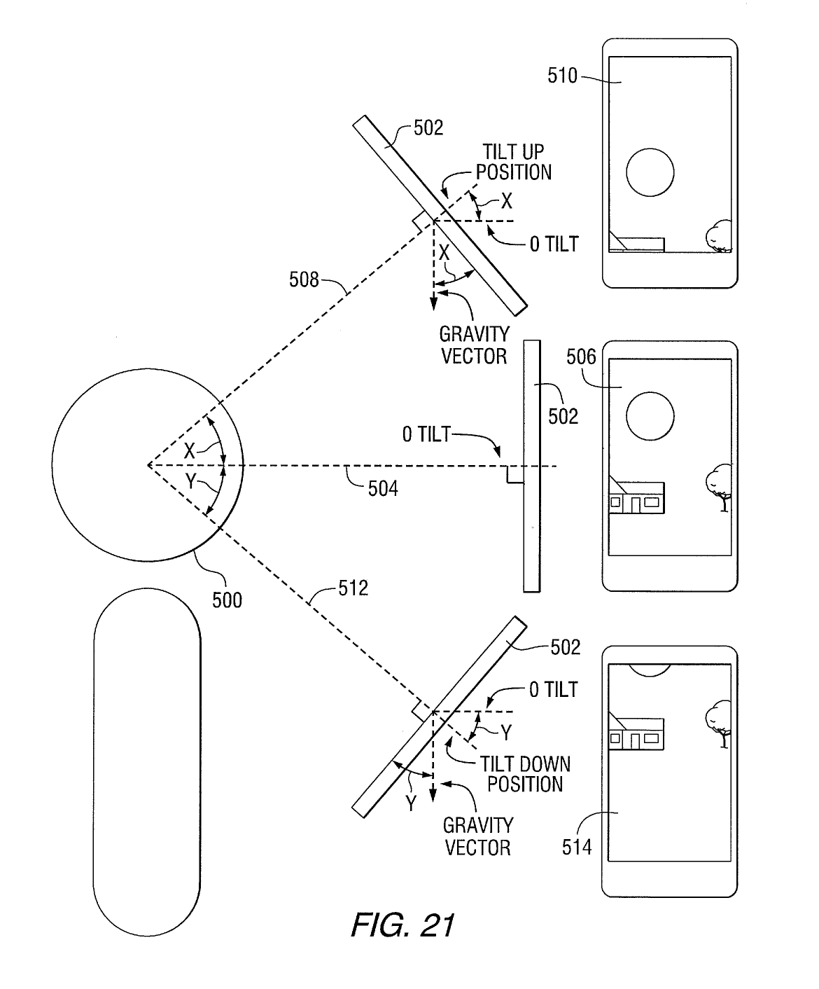

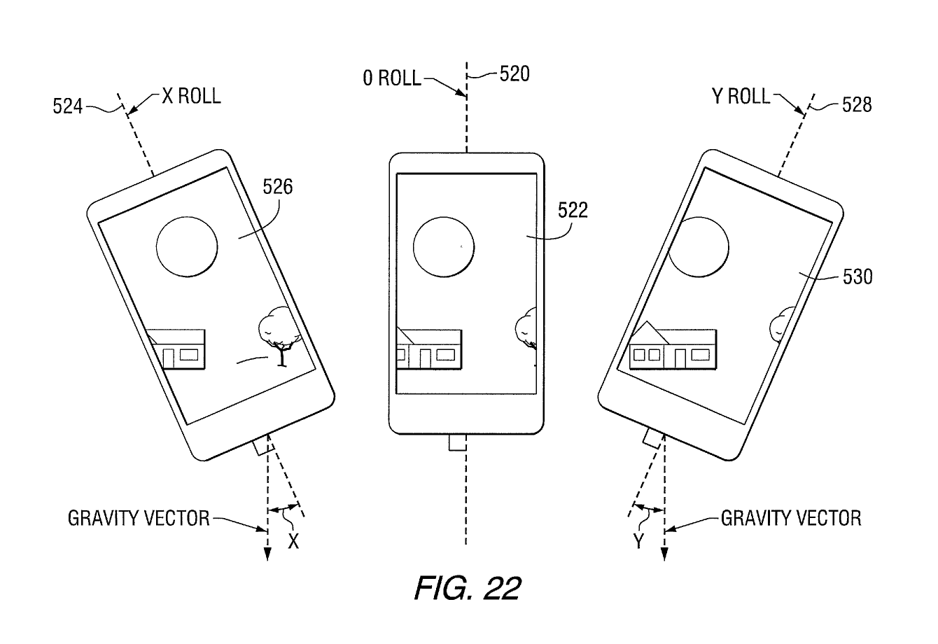

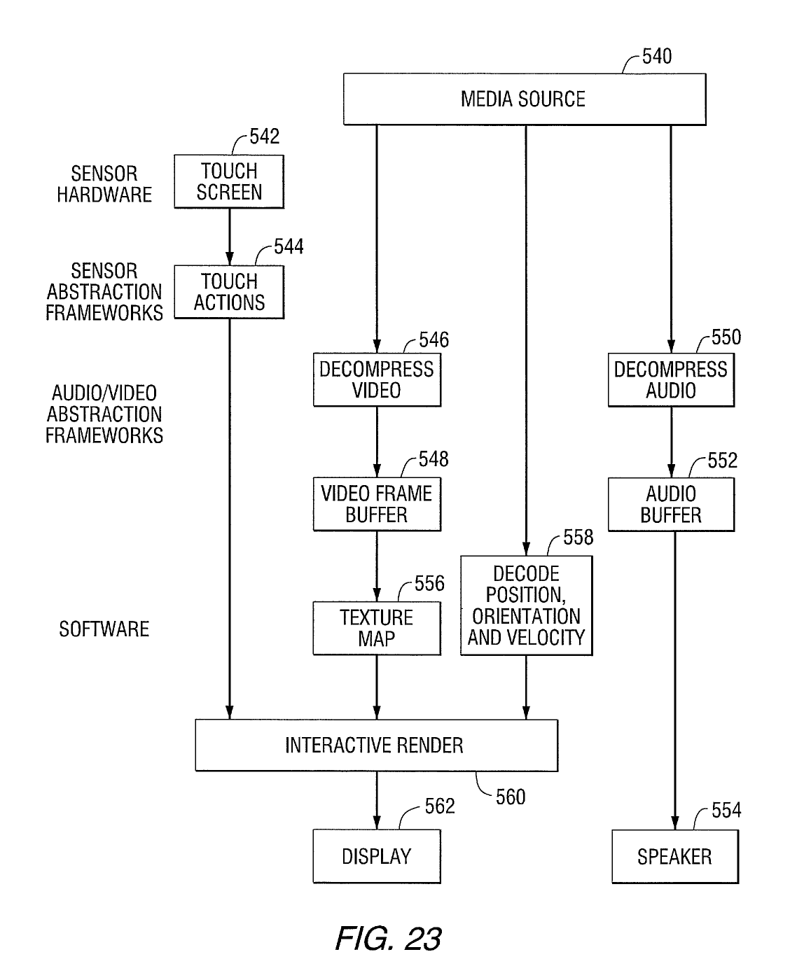

FIG. 21 is a block diagram illustrating tilt control. In FIG. 21, the media source 540 is the combined storage of compressed or uncompressed video, audio, position, orientation, and velocity data. Media sources can be prerecorded, downloaded, or streamed from a network connection. The media source can be separate from the iPhone®, or stored in the iPhone®. For example, the media may be resident on the phone, may be in the process of downloading from a server to the phone, or only a few frames/seconds of video from a stream may be stored on the phone in a transient manner.

The touch screen 542 is a display found on many mobile computing devices, such as the iPhone®. The touch screen contains built-in touch or touch screen input sensors that are used to implement touch actions 544. In usage scenarios where a software platform does not contain a built-in touch or touch screen sensor, externally connected off-the-shelf sensors can be used. User input in the form of touching, dragging, pinching, etc, can be detected as touch actions by touch and touch screen sensors though the usage of off the shelf software frameworks.

User input in the form of touch actions can be provided to a software application by hardware abstraction frameworks on the software platform to provide the user with an interactive presentation of prerecorded media, shared media downloaded or streamed from the internet, or media which is currently being recorded or previewed.

Many software platforms provide a facility for decoding sequences of video frames using a decompression algorithm, as illustrated in block 546. Common algorithms include AVC and H.264. Decompression may be implemented as a hardware feature of the mobile computing device, or through software which runs on the general CPU, or a combination thereof. Decompressed video frames are passed to the video frame buffer 548.

Many software platforms provide a facility for decoding sequences of audio data using a decompression algorithm, as shown in block 550. One common algorithm is AAC. Decompression may be implemented as a hardware feature of the mobile computing device, or through software which runs on the general CPU, or a combination thereof. Decompressed audio frames are passed to the audio frame buffer 552 and output to a speaker 554.

The video frame buffer 548 is a hardware abstraction provided by any of a number of off the shelf software frameworks, storing one or more frames of decompressed video. These frames are retrieved by the software for various uses.

The audio buffer 552 is a hardware abstraction that can be implemented using known off the shelf software frameworks, storing some length of decompressed audio. This data can be retrieved by the software for audio compression and storage (recording).

The texture map 556 is a single frame retrieved by the software from the video buffer. This frame may be refreshed periodically from the video frame buffer in order to display a sequence of video.

The functions in the Decode Position, Orientation, and Velocity block 558 retrieve position, orientation, and velocity data from the media source for the current time offset into the video portion of the media source.

An interactive renderer 560 combines user input (touch actions), still or motion image data from the media source (via a texture map), and movement data from the media source to provide a user controlled view of prerecorded media, shared media downloaded or streamed over a network. User input is used in real time to determine the view orientation and zoom. The texture map is applied to a spherical, cylindrical, cubic, or other geometric mesh of vertices, providing a virtual scene for the view, correlating known angle coordinates from the texture with the desired angle coordinates of each vertex. Finally, the view is adjusted using orientation data to account for changes in the pitch, yaw, and roll of the original recording apparatus at the present time offset into the media.

Information from the interactive render can be used to produce a visible output either an integrated display device 562 such as the screen on an iPhone®, or an externally connected display device.

The speaker provides sound output from the audio buffer, synchronized to video being displayed from the interactive render, using either an integrated speaker device such as the speaker on an iPhone®, or an externally connected speaker device. In the event that multiple channels of audio data are recorded from a plurality of microphones in a known orientation, the audio field may be rotated during playback to synchronize spatially with the interactive renderer display.

Examples of some applications and uses of the system include: motion tracking; social networking; 360 mapping and touring; security and surveillance; and military applications.

For motion tracking, the processing software can be written to detect and track the motion of subjects of interest (people, vehicles, etc) and display views following these subjects of interest.

For social networking and entertainment or sporting events, the processing software may provide multiple viewing perspectives of a single live event from multiple devices. Using geo-positioning data, software can display media from other devices within close proximity at either the current or a previous time. Individual devices can be used for n-way sharing of personal media (much like YouTube® or Flickr®). Some examples of events include concerts and sporting events where users of multiple devices can upload their respective video data (for example, images taken from the user's location in a venue), and the various users can select desired viewing positions for viewing images in the video data. Software can also be provided for using the apparatus for teleconferencing in a one-way (presentation style—one or two-way audio communication and one-way video transmission), two-way (conference room to conference room), or n-way configuration (multiple conference rooms or conferencing environments).

For 360° mapping and touring, the processing software can be written to perform 360° mapping of streets, buildings, and scenes using geospatial data and multiple perspectives supplied over time by one or more devices and users. The apparatus can be mounted on ground or air vehicles as well, or used in conjunction with autonomous/semi-autonomous drones. Resulting video media can be replayed as captured to provide virtual tours along street routes, building interiors, or flying tours. Resulting video media can also be replayed as individual frames, based on user requested locations, to provide arbitrary 360° tours (frame merging and interpolation techniques can be applied to ease the transition between frames in different videos, or to remove temporary fixtures, vehicles, and persons from the displayed frames).

For security and surveillance, the apparatus can be mounted in portable and stationary installations, serving as low profile security cameras, traffic cameras, or police vehicle cameras. One or more devices can also be used at crime scenes to gather forensic evidence in 360° fields of view. The optic can be paired with a ruggedized recording device to serve as part of a video black box in a variety of vehicles; mounted either internally, externally, or both to simultaneously provide video data for some predetermined length of time leading up to an incident.

For military applications, man-portable and vehicle mounted systems can be used for muzzle flash detection, to rapidly determine the location of hostile forces. Multiple devices can be used within a single area of operation to provide multiple perspectives of multiple targets or locations of interest. When mounted as a man-portable system, the apparatus can be used to provide its user with better situational awareness of his or her immediate surroundings. When mounted as a fixed installation, the apparatus can be used for remote surveillance, with the majority of the apparatus concealed or camouflaged. The apparatus can be constructed to accommodate cameras in non-visible light spectrums, such as infrared for 360 degree heat detection.

Whereas particular embodiments of this invention have been described above for purposes of illustration, it will be evident to those skilled in the art that numerous variations of the details of the described embodiments may be made without departing from the invention.

What is claimed is:

1. An apparatus comprising:
a housing;
a concave panoramic reflector;
a support structure configured to hold the concave panoramic reflector in a fixed position with respect to the housing; and
a mounting device for positioning the housing in a fixed orientation with respect to a computing device such that light reflected by the concave panoramic reflector is directed to a light sensor in the computing device.

2. The apparatus of claim 1, wherein a portion of the concave panoramic reflector is positioned outside of the housing and displaced from an end of the housing in an axial direction to form an opening between an edge of the concave panoramic reflector and the end of the housing.

3. The apparatus of claim 2, wherein the shape of the concave panoramic reflector defines a vertical field of view.

4. The apparatus of claim 1, further comprising:
a mirror positioned to reflect light from the concave panoramic reflector to the light sensor, wherein the mirror is sized to encompass a field of view of a camera in the computing device.

5. The apparatus of claim 1, wherein at least a portion of the housing has a substantially frustoconical shape.

6. The apparatus of claim 1, wherein the support structure comprises:
a transparent member positioned in the housing in a plane perpendicular to an axis of the housing; and
a central opening configured to accept a post coupled to the concave panoramic reflector.

7. The apparatus of claim 1, wherein the mounting device comprises:
a case for the mobile computing device, wherein the case is configured to couple to the housing.

8. The apparatus of claim 7, wherein the case includes an oblong opening configured to make an interference fit with a substantially oblong protrusion on the housing.

9. The apparatus of claim 7, wherein the case includes a keyed opening configured to receive a keyed protrusion on the housing.

10. The apparatus of claim 7, wherein the case includes a bayonet opening configured to receive a protrusion on the housing.

11. The apparatus of claim 7, wherein the case includes a magnet configured to couple to a magnet on the housing.

12. The apparatus of claim 7, wherein the case includes an alignment well configured to receive an alignment bump on the housing.

13. The apparatus of claim 7, wherein the case includes an opening configured to receive a winged protrusion on the housing.

14. The apparatus of claim 7, wherein the case includes a plurality of openings configured to receive pins on the housing.

15. The apparatus of claim 7, wherein the case includes a lip configured to grip the bevel along an outside edge of a screen on the mobile computing device.

16. The apparatus of claim 15, wherein the lip holds a back face of the case in tension against a back of the mobile computing device.

17. The apparatus of claim 7, wherein the case includes two parts that slide onto the mobile computing device.

18. The apparatus of claim 17, wherein the two parts are joined by a pair of parallel, angled surfaces, forming an interference fit when the two parts are slid onto the mobile computing device and then pressed together.

19. The apparatus of claim 7, the case includes an opening configured to receive a protrusion on the housing and allowing the protrusion to slide into a position adjacent to a camera opening.

20. The apparatus of claim 1, wherein the concave panoramic reflector has a shape defined by one of the following equations:
$$\frac{d r}{d ( θ + \frac{A}{α} )} = r cot ( k tan ( θ + \frac{A}{α} ) + \frac{π}{2} - k tan ( {R}_{cs} ) - \frac{{R}_{cs}}{2} ) ;$$
$$\frac{d r}{d ( θ + \frac{A}{α} )} = r cot ( k tan ( θ + \frac{A}{α} ) + \frac{π}{2} ) ; or$$
$$\frac{d r}{d θ} = r cot ( k tan ( θ ) + \frac{π - A}{2} - k tan ( {R}_{cs} ) - \frac{{R}_{cs}}{2} )$$
wherein, A is the angle between the direction of a ray rₒ and a line parallel to the camera axis 294 in radians; R_{cs} is the angle between the camera axis and a point on the mirror that reflects ray rₒ in radians; R_{ce} the angle between the camera axis and an edge of the mirror in radians; rₒ is the inner radius in millimeters; α is the gain factor; θ is the angle between the camera axis and the reflected ray r in radians; and k is defined in terms of α in the first equation.
